(19) United States
(12) Patent Application Publication
(10) Pub. No.: US 2008/0083303 A1
(43) Pub. Date: Apr. 10, 2008

(54) Pneumatic Ratchet with Resettable Forward/Reverse Actuator

(76) Inventor: David Baker, Fort Lawn, SC (US)

Correspondence Address: SCHMEISER, OLSEN & WATTS, 22 CENTURY HILL DRIVE, SUITE 302, LATHAM, NY, 12110, US

(21) Appl. No.: 11/615,855

(22) Filed: Dec. 22, 2006

Related U.S. Application Data
(63) Continuation-in-part of application No. 10/848,639, filed on May 19, 2004.

(51) Int. Cl. B25B 13/46

(52) U.S. Cl. 81/57.39

(57) ABSTRACT

A pneumatic ratchet wrench that has a shift linkage system that allows the user to visually discern which direction the rotating anvil of the wrench will rotate without using the throttle. The shift linkage system is also configured conveniently so that the user can both use the wrench throttle and the linkage system via one hand. The shifting linkage, a linkage system, and method of shifting the rotational direction of the anvil is also disclosed.

### CROSS REFERENCE TO RELATED APPLICATIONS

This is a continuation-in-part of U.S. patent application Ser. No. 10/848,639 filed May 19, 2004, the contents of which are incorporated in their entirety.

### BACKGROUND OF THE INVENTION

1. Technical Field

The invention relates generally to a pneumatic ratchet with a forward/reverse actuator that allows resetting between forward and reverse rotations of the anvil.

2. Related Art

In the art of ratchets and pneumatic ratchets, there is a need for an improved switching of a pneumatic ratchet.

### SUMMARY OF THE INVENTION

The present invention offers an improved pneumatic ratchet with a forward/reverse actuator that inter alia allows for one handed operation/direction switching.

A first general aspect of the invention provides a selector of a ratchet and pawl system comprising: an actuator; and a selector having a first ratchet position and a second ratchet position, said selector is moveably attached to the actuator, wherein orientation between said selector and said actuator is resettable.

A second general aspect of the invention provides a pneumatic ratchet wrench with resettable shifting linkage comprising: a housing; a rotating output; a motor positioned within the housing; a ratchet assembly having at least one pawl coupled to the rotating output and the motor; a transfer rod, said rod having a first end and a second end; a switch mounted on the housing and configured for user activation, said switch functionally attached to the first end of the transfer rod; an actuator that operatively engages a second end of the transfer rod during movement of the switch; and a selector to move said pawl, said selector having a first ratchet position and a second ratchet position to control direction of the rotating output, said selector is moveably attached to the actuator, wherein orientation between said selector and said actuator is resettable.

A third general aspect of the invention provides a pneumatic ratchet wrench with resettable shifting linkage comprising: a housing; a motor positioned within the housing; a ratchet assembly having at least one pawl coupled to the motor; a transfer rod, said rod having a first end and a second end; a switch mounted on the housing and configured for user activation, said switch functionally attached to the first end of the transfer rod; an actuator that operatively engages a second end of the transfer rod during movement of the switch; a selector to move said pawl; and a biasing element moveably joining the actuator and the selector, said biasing element provides tension between the actuator and the selector allowing resetting of the selector switch when force from the selector switch exceeds the force of the biasing element.

A forth general aspect of the invention provides a method for resetting the rotational direction of a rotating anvil of a pneumatic ratchet wrench, said method comprising: providing a shifting linkage having a first end functionally attached to a switch configured for user activation, said linkage further having a second end that operatively engages an actuator; providing a selector moveably attached to the actuator, said selector causes movement of a pawl to change the direction of rotation of a ratchet mechanism; providing a low torque clutch between the selector and the actuator; activating said switch causing rotation of the actuator causing either direction of said rotating anvil to change from a first position to a second position or rotation of the selector with respect to the actuator to rest lost timing.

The foregoing and other features and advantages of the invention will be apparent from the following more particular description of embodiments of the invention. It is to be understood that both the foregoing general description and the following detailed description are exemplary, but are not restrictive, of the invention.

### BRIEF DESCRIPTION OF THE DRAWINGS

Some of the embodiments of this invention will be described in detail, with reference to the following figures, wherein like designations denote like members, wherein:

FIG. 1 depicts a side sectional view of a pneumatic ratchet, in accordance with the present invention;

FIG. 2 depicts a top view of a pneumatic ratchet with partial removal, in accordance with the present invention;

FIG. 3 depicts a top view of a pneumatic ratchet with partial removal, with a shift linkage in a first and a second position, in accordance with the present invention;

FIG. 4A is a top, diagrammatic view of a pneumatic ratchet while an anvil is in the forward rotational direction, in accordance with the present invention;

FIG. 4B is a top, diagrammatic view of a pneumatic ratchet while an anvil is in the reverse rotational direction, in accordance with the present invention;

FIG. 5 is a view of the resettable gear; and

FIG. 6 is a top perspective view of the resettable gear.

### DETAILED DESCRIPTION OF THE INVENTION

Although certain preferred embodiments of the present invention will be shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of an embodiment. The features and advantages of the present invention are illustrated in detail in the accompanying drawings, wherein like reference numerals refer to like elements throughout the drawings.

As a preface to the detailed description, it should be noted that, as used in this specification and the appended claims, the singular forms “a”, “an” and “the” include plural referents, unless the context clearly dictates otherwise.

The present invention offers a pneumatic ratchet with a forward/reverse actuator that inter alia allows for one handed reversal of rotational direction of an anvil or output, further wherein the user can visually discern the rotational direction of the anvil or output, concurrently while either engaging, or not engaging, the throttle. The present invention may further allow for the switching between forward and reverse rotational direction of the anvil or output with the concurrent engagement of the throttle without having to reposition the user's hand.

Thus, the present invention offers greater flexibility, greater ease of use, greater safety, and more options, than current pneumatic ratchets do. The term pneumatic ratchet as used herein denotes an air powered hand tool to be used in conjunction with at least one rotatable anvil or output.

The present invention provides for one handed operation of a pneumatic ratchet with the ability to change the direction of rotation of the anvil or output as well as the ability to discern the direction of rotation upon visual inspection of the position of the actuator mechanism with or without simultaneously engaging the throttle.

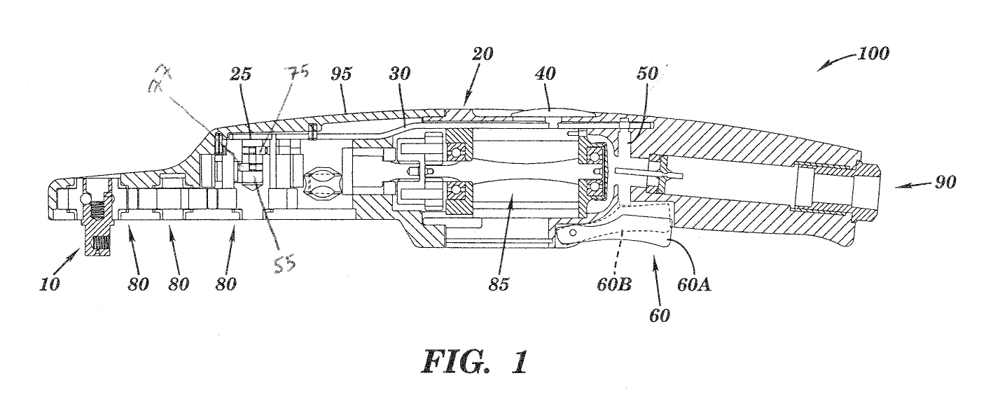

Referring to the drawings, FIG. 1 depicts a side sectional view of an embodiment of a pneumatic ratchet in accordance with the present invention. As depicted, a pneumatic ratchet wrench 100 has an outer housing 95, a connector 90 to an air source (e.g., air compressor) (not shown), a motor 85, a plurality of offset gears 80, a rotatable anvil, output or drive end 10, and a throttle 60 shown in an unengaged position 60A, and the throttle 60 shown in phantom in an engaged position 60B. A shift linkage system 20 may be comprised of a forward-reverse switch 40 and a shift linkage 30. A forward-reverse actuator 25 operatively engages both with a portion of the shift linkage system 20 and the offset gears 80.

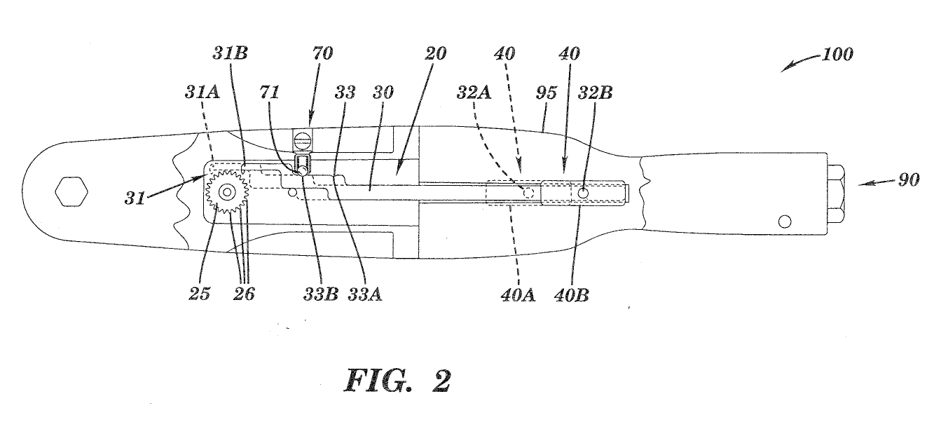

A throttle pin 50, may act as an optional safety mechanism, by not allowing for the throttle 60 to go into the engaged position 60B when the forward-reverse actuator switch 40 is in neither a first position 32A or a second position 32B (see FIG. 2). Engagement of the throttle 60B when the switch 40 is not properly placed may cause damage to the tool 100.

FIG. 2 depicts a top view of the pneumatic ratchet 100 with partial removal of the housing 95 to facilitate viewing of aspects of the invention. The pneumatic ratchet wrench 100 has an outer housing 95, a connector 90 to an air source, such as an air compressor (not shown), a shift linkage system 20, a forward-reverse actuator 25, and an anvil or output 10. The actuator 25 may resettable or non-resettable either would function to change the direction of rotation of tool 100.

The shift linkage system 20 may include an elongate shift linkage 30. At one end of the shift linkage 30 is an engagement end 31, while at the second end is a forward-reverse switch 40. Also located on the shift linkage 30 may be a pair of detents 33 (i.e., a first detent 33A and a second detent 33B) which allow for the engagement of a spring-biased ball 71 with the shift linkage 30. The shift linkage 30 has at least two general positions. In a first position, which is shown in phantom, the switch 40, is slid forward to a first position 40A (shown in phantom); the engagement end 31 is a first position 31A; and, the ball 71 is engaged with a first detent 33A. Conversely, the shift linkage 30 has a second position (shown in solid). In the second position, the switch 40 is slid backwards to a second position 40B; the engagement end 31 is in the second position 31B; and, the ball 71 is engaged with the second detent 33B.

Thus, the sliding of the switch 40 from its first position 40A to its second position 40B causes the engagement end 31 to move from its first position 31A to its second position 31B, between which the engagement end 31 engages, and rotates the actuator 25 via its teeth 26. Similarly, the sliding of the switch 40 from its second position 40B to its first position 40A causes the engagement end 31 to move from its second position 31B to its first position 31A, between which the engagement end 31 engages, and rotates the actuator 25 via its teeth 26. Depending on which of the two positions that the switch 40 is moved from, will result in rotation of the actuator 25 in a opposite rotational directions. If the actuator 25 is timed properly the movement of the switch 40 will cause movement of selector 55 thereby changing the direction of rotation.

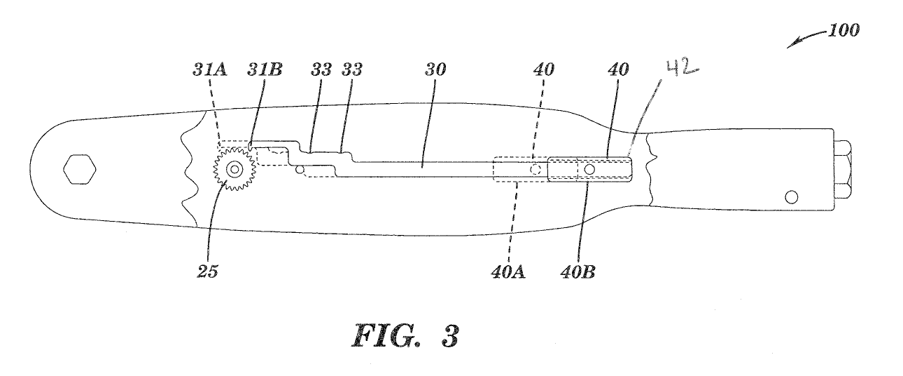

FIG. 3 depicts a similar view as in FIG. 2, but with more portions of the tool 100 removed for clarity's sake. As can be seen, the engagement end 31 is shown in a first position 31A (in phantom) and in a second position 31B. Correspondingly, the forward-reverse switch 40 is shown in phantom in the first position 40A and in the second position 40B.

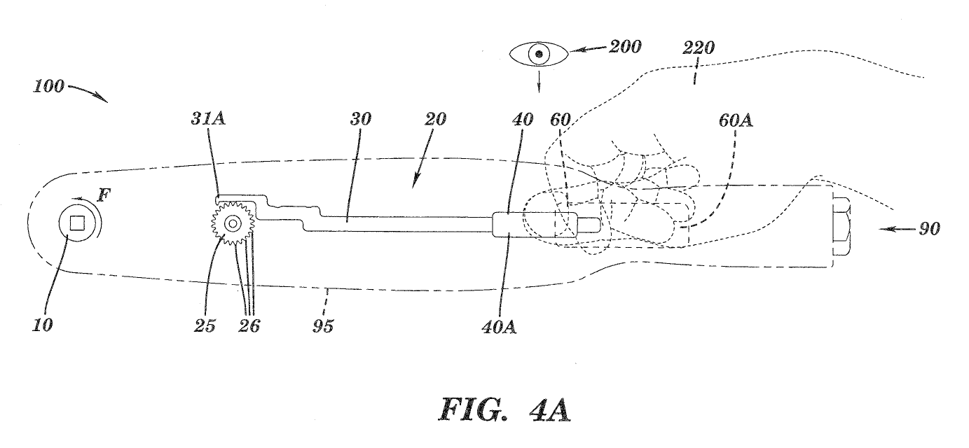

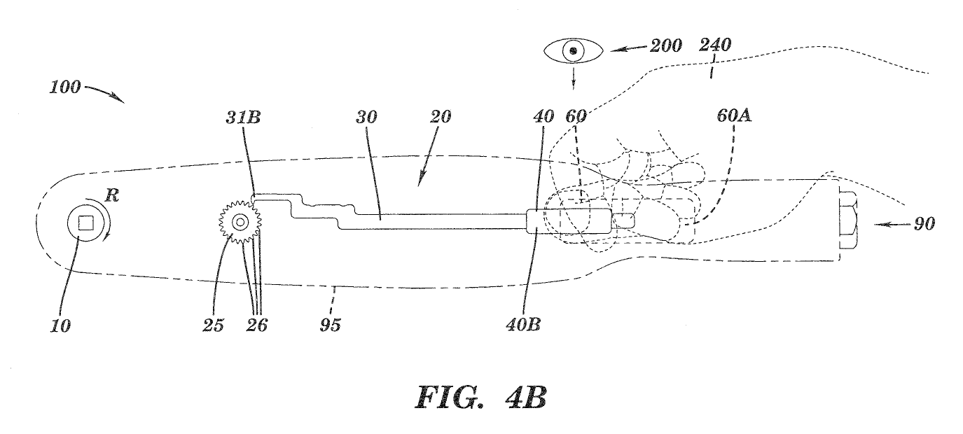

FIGS. 4A and 4B show a top, schematic, or diagrammatic, view of the tool 100 with a users's hand 220 and eye 200 during the use thereof. When timed correctly the visual position of the selector 40 as seen by the user's eye 200 may match the actual direction of rotation of the anvil or output 10.

FIG. 4A shows the user's hand 220 holding an embodiment with the switch in the first position 40A where the user may visually ascertain from their eye 200 the forward rotational direction of the anvil or output 10 without engaging the throttle 60 if the system is properly timed. The shift linkage system 20 is oriented with the switch 40 is in the first position 40A. When the switch 40 is moved from the second position 40B (See e.g., FIG. 4B) to the first position 40A, the switch 40 causes the shift linkage 30 to interact with the forward-reverse actuator 25 (via the engagement of the engagement end 31 with the teeth 26 of the actuator 25) which in turn acts upon a ratchet and pawl system to allow rotation motion of the anvil or output 10, in the forward (i.e., tightening) direction as denoted by directional arrow “F”. Thus, the user can visually discern 200 what the rotational direction of the anvil or output 10 will be with, or without, engaging the throttle 60. Further, the invention allows for the ability to engage the throttle 60 (i.e., move throttle to position 60B as in FIG. 1) as well as change the rotational direction of the anvil or output 10 with only the use of one hand 220.

FIG. 4B is the same view as in FIG. 4A, but conversely, showing the user's hand 240 engaging the switch 40 in a second position 40B. Similarly, the user can see from the user eye 200 what rotational direction of the anvil or output 10 will be without engaging the throttle 60B. With the switch 40 in the second position 40B, the shift linkage system 20 is moved rearward along the tool 100 so that the engagement end 31 is the second position 31B. So, when the switch 40 is moved from the first position 40A (See FIG. 4A) to the second position 40B, the engagement end 31 interacts with the gear teeth 26 of the forward-reverse actuator 25 which in turn may acts upon a ratchet and pawl system so that the rotational direction of the anvil or output 10 is switched to the reverse (i.e., loosening) direction, as depicted by directional arrow “R” if the system is properly timed.

The selector 55 may be in a first rotational position while the switch 40 is in a second position and visually indicating an opposite rotational position, which is a condition known as being mistimed or lost timing. This can cause confusion by the operator and potential jamming of the switch if the direction of the actuator and the pawls are mismatched caused by unintentional contact of the actuator 25 with an object other than the end 31 of the rod 30 or a partial toggling of the switch, which changes direction of the selector 55, but the switch 40 returns to the original position.

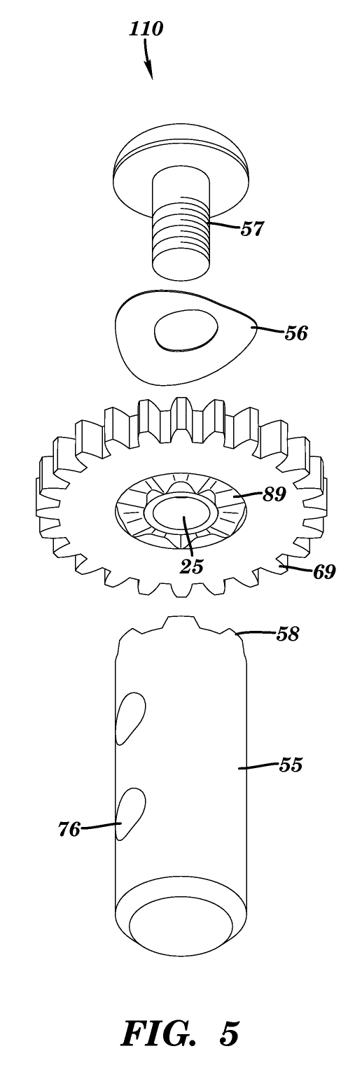

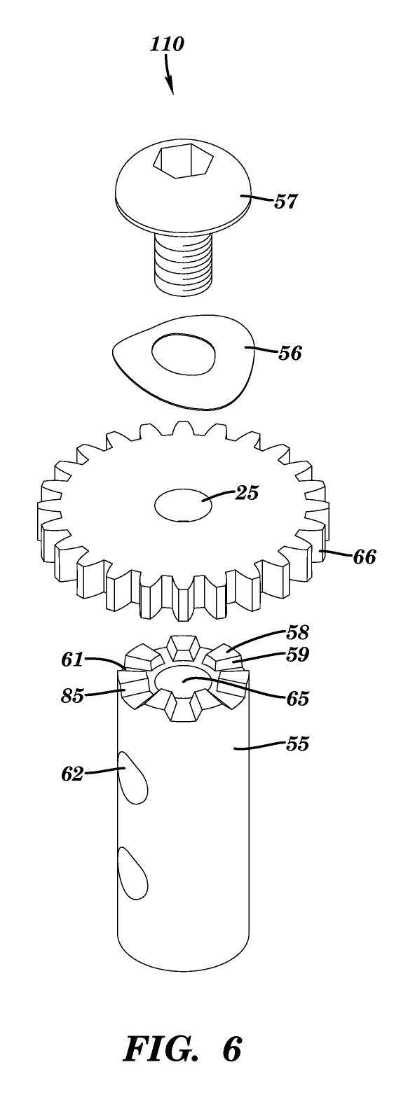

The embodiments shown in FIG. 1-4B may be further modified as shown in FIGS. 5 and 6 to provide a solution to the potential problem of mistiming with a resettable shifting linkage for switching the rotational direction of a rotating anvil or output of a pneumatic ratchet wrench. A selector of a ratchet and pawl system 110 comprises an actuator 25 and a selector 55 having a first ratchet position and a second ratchet position. Selector 55 is movably attached to actuator 25 and the orientation between actuator 25 and selector 55 is resettable so that the timing is restored. The timing is restored when actuator 25 is caused to rotate by switch 40 until it matches the position of selector 55.

A plurality of gear teeth 26 on the actuator 25 are configured for operative engagement with a switch 40. Switch 40 may not be in contact with actuator 25, or the plurality of gear teeth 26 except when switching from position 32A to 32B of switch 40. While switching from position 32A to 32B, switch 40 is brought into contact with gear teeth 26, causing actuator 25 to make a partial rotation. The rotation of the actuator 25 may cause rotation of the selector 55 if the timing is proper, otherwise it will reset the timing.

A reset clutch 85 may be positioned between actuator 25 and selector 55 to reset lost timing by selectively moving the actuator 25 with respect to the selector 55. Reset clutch 85 is any means to control the movement between actuator 25 and selector 55 using friction of the surfaces between the actuator 25 and selector 55. Reset clutch 85 could be a frictional surface such as a first surface having a protruding shape and the second surface having a corresponding depression, either on a micro or macro scale. The first surface on a macro scale may also have a plurality of protruding shapes such as angled teeth 58, and the second surface may have a plurality of corresponding depressions 69. The surfaces also may have properties that would increase friction between the two surfaces.

A first actuator position causes an anvil 10 to rotate in a forward rotational direction and a second actuator position causes an anvil 10 to rotate in a reverse rotational direction.

A fastener 57 may movably join actuator 25 and selector 55 and a biasing element 56 that provides tension between the actuator 25 and the selector 55. The fastener 57 may be a bolt, screw, rivet, rod and cotter pin, or other known type of fasteners may force the biasing element 56 against the actuator 25. Biasing element 56 may be a spring or resilient member that could be spring steel or other resilient material but could also be a coiled wire, a wave washer, or any non-planar surface that stores force and allows for controlled movement by deforming and then reforming to its original position.

A selector mating surface 69 on actuator 25 and actuator mating surface 85 on selector 55 may be configured in a frictional lock. This means that actuator 25 and selector 55 rotate as a single unit until the frictional lock is exceeded by a force applied to move actuator 25. The force required to move actuator 25 is dependent on the amount of force applied by the frictional lock. This force applied to move actuator 25 may be applied by a user through switch 40 when restoring the timing of actuator 25.

A plurality of obtuse angled teeth 58 may be circularly arranged around end 61of selector 55 and a plurality of depressions are circularly arranged around the actuator mating surface 89 of actuator 25. This forms a low torque clutch 59 wherein rotation of the actuator 25 with respect to selector 55 causes depressions 69 to slip and to remate with the plurality of obtuse angled teeth 58. A low torque geared slip clutch surface 59 is positioned between an end of the selector 61 and an end of the actuator 89. The low torque geared slip clutch surface 59 is controlled by the rotational force required to overcome the biasing element 56 allowing it to jump to a new position. The rotational force required to overcome the biasing element 56 should be between 1 to 50 inch pounds and should be easily rotated using the switch 40 if mistimed.

Furthermore, there may be at least one chamber 76, 62 in selector 55 that may be configured to accept a spring to keep a pawl 75 in tension. Chamber 76, 62 also may be configured to accept a ball and spring combination. Upon moving switch 40 from position 32A to 32B, actuator 25 is rotated which in turn rotates selector 55, moving pawl 75 to change direction of the ratchet mechanism 77.

The improved shifting linkage comprises a transfer rod 30, said rod 30 having a first end 42 and a second end 31. A switch 40 configured for user activation functionally attached to the first end 42 of the transfer rod 30. An actuator 25 that operatively engages a second end 31 of the transfer rod 30 during movement of the switch 40. The actuator 25 then interacts with the selector 55 that then moves the pawl 77 to change the direction of rotation of the tool 100.

A selector 55 interacts with a ratchet and pawl system 77 of said pneumatic ratchet wrench 100 to change the direction of ratcheting and thus the direction of rotation. The selector 55 has a clockwise rotation position and counterclockwise rotation position that may correlate to a first ratchet position 32A and a second ratchet position 32B, as may be indicated by a visual indicator on the wrench 100 unless the condition of mistiming or lost timing is present. In the case of lost timing said selector 40 is moveably attached to the actuator 25, wherein orientation between said selector 55 and said actuator 25 is resettable so that the timing is restored. The timing may be restored when actuator 25 rotates until it matches the position of the selector 55. The switch 40 may include a plurality of detents (a first detent 33A and second detent 33B) in the switch 40.

The rotation between the actuator 25 and the selector 55 may be controlled by a reset clutch 85 positioned between the actuator 25 and the selector 55. The reset clutch 85 is any frictional surface having a controlled release allowing controlled movement between the actuator 25 and the selector 55 to reset timing. The reset clutch 85 could be one or more surfaces on the actuator 25 and the selector 55, such as a first surface having a protruding shape and a second surface having a corresponding depression. The resetting of timing may be provided by a low torque geared slip clutch surface 59 (teeth resting in a corresponding depression allowing omnidirectional ratcheting) positioned between an end of the selector 58 and an end of the actuator 89.

There may be a plurality of gear teeth 26 on the actuator 25 for engagement with said second end 31. The second end 31 may not be in contact with the actuator 25 except during the actual transition between the first position 32A and the second position 32B of the switch 40. The switch 40 may have a first switch position 40A that may cause the anvil, output or drive end 10 to rotate in a forward rotational direction and a second switch position 40B that may cause the anvil, output or drive end 10 to rotate in a reverse rotational direction. Optionally a throttle pin may be adapted to prevent operating of a throttle 60 when said linkage or rod 30 is neither in said first position 32A or said second position 32B.

The resettable shifting linkage may optionally contain a biasing element 56. The biasing element 56 may be a spring or resilient member such as spring steel or other resilient material to would retain shape after being deformed. The spring steel could be formed into a coiled wire, a wave washer, or any non-planar surface. A fastener 57 may moveably join the actuator 25 and the selector 55 with the biasing element 56, which provides for compression of the biasing element 56 and thus tension between the actuator 25 and the selector 55. Therefore, the amount of force required to rotate the actuator 25 with respect to the selector 55 may be controlled by the force provided by the biasing element in conjunction with any frictional forces between the surface of the actuator 25 in contact with the surface of the selector 55. To control the amount of slip a selector mating surface 85 on the selector 55 and an actuator mating surface 89 on the actuator 25, wherein the selector mating surface 85 and the actuator mating surface 89 are in a frictional lock, wherein said actuator 25 and said selector 55 rotate as a single unit until the frictional lock is exceeded by the force applied to move the switch 40.

The resettable timing feature may include a plurality of obtuse angled teeth 59 circularly arranged on a surface (85, 89) between the actuator 25 and the selector 55. This corresponds to a plurality of depressions 69 circularly arranged, wherein said teeth 59 mate into said depressions 69 and are positioned between the actuator 25 and the selector 55 forming a low torque clutch, wherein rotation of the actuator 25 with respect to the selector 55 causes said teeth 59 to slip and to remate with the plurality of obtuse angled teeth 59.

Another embodiment may be a pneumatic ratchet wrench 100 with resettable shifting linkage comprises a motor 85 positioned within a housing 95. The resettable linkage allows for the correction of lost timing caused by shifting the direction of the rotation of the drive end 10 that has occurred without using the switch 40. A ratchet assembly 77 having at least one pawl 75 coupled to the motor 85 through offset gears 80. A transfer rod 30, said rod 30 having a first end 31 and a second end 42 is what allows for the remote shifting of direction of the ratchet wrench 100. A switch 40 is mounted on the housing 95 and configured for user activation, said switch 40 functionally attached to the second end 42 of the transfer rod 30.

To change direction of ratchet rotation an actuator 25 is operatively engaged by a first end 31 of the transfer rod 30 during movement of the switch 40. The tool 100 has a first switch position that causes the anvil or output to rotate in a forward rotational direction and a second switch position that causes the anvil or output to rotate in a reverse rotational direction. The actuator 25 is moveably attached to a selector 55 to move said pawl 75, said selector 55 having a first ratchet position 78 and a second ratchet position 79.

The selector 55 is moveably attached to the actuator 25 is what allows for the resetting of the timing. The orientation between the selector 55 and the actuator 25 is resettable by the rotation of the actuator 25 with respect to a fixed selector 55. The selector 55 may become fixed either when it is in a forward or reverse rotation orientation position and the switch is in an opposite rotation position. The selector 55 becomes fixed in either a forward or reverse rotation position and then movement of the switch 40 causes the engagement of rod end 31 with a plurality of gear teeth 26 on the actuator 25 for engagement with said second end 31.

The actuator 25 and selector 55 may use a myriad of techniques to control their orientation with respect to each other to correct the timing of the switch 40 with respect to the direction of rotation of the drive end 10. Another method to control the orientation is with a plurality of obtuse angled teeth 59 circularly arranged and a plurality of depressions 69 circularly arranged, wherein said teeth 59 mate into said depressions 69 and are positioned between the actuator 25 and the selector 55 forming a low torque clutch, wherein rotation of the actuator 25 with respect to the selector 55 causes said teeth 59 to slip and to remate with the plurality of depressions. Another way to reset timing by between the actuator 25 and the selector 55 is to use spring loaded detents that when sufficient torque is applied by the switch 40 the spring loaded detents would retract and allow change of the orientation between the actuator 25 and the selector 55. Moreover, another way to reset timing between the actuator 25 and the selector 55 may be to include at least one frictional surface 85 positioned between the actuator 25 and the selector 55.

Another embodiment is a pneumatic ratchet wrench 100 with resettable shifting linkage comprising a housing 95 having a motor 85 positioned within the housing 95. A ratchet assembly 77 having at least one pawl 75 may be coupled to the motor 85. A switch 40 may be mounted on the housing 95 and configured for user activation, said switch 40 functionally attached to the first end of the linkage, elongated member or transfer rod 30. The transfer rod 30 having a first end 42 and a second end 31 with a pick like tip to move or rotate an actuator 25 that operatively engages a second end 42 of the transfer rod 30 during movement of the switch 40. A selector 55 having a member 76 such as a ball and spring to move said pawl 75 to change direction of ratcheting of the pawl 75.

A biasing element 56 moveably joins the actuator 25 and the selector 55, said biasing element 56 provides tension between the actuator 25 and the selector 55 allowing resetting of the selector switch 40 when force from the selector switch 40 exceeds the force of the biasing element. The biasing element 56 may be wave washer such as a Belville wave washer or any other type of spring like element. A fastener member 57 such as a bolt, screw, rivet, rod and cotter pin, or other known type of fasteners may force the biasing element against the actuator 25. The fastener member 57 may be attached to a mounting portion 65 that may contain threads on the selector 55. The fastener member 57 may retain the actuator 55 by passing through a retain hole 66.

The timing reset feature uses the biasing element 56 tensioned by the fastener member 57 that interacts with a selector mating surface 85 on the selector 55 and an actuator mating surface 89 on the actuator 25, wherein the selector mating surface 85 and the actuator mating surface 89 are in a frictional lock, wherein said actuator 25 and said selector 55 rotate as a single unit until the frictional lock is exceeded by the movement of the selector switch 40. The frictional lock between the mating surfaces 85, 89 may be made into a low torque geared slip clutch surface positioned between an end of the selector and an end of the actuator with the addition of at least one protrusion and one depression that mate, wherein the protrusion has width at least twice its height and the depression has a depth no more than half the width. A bidirectional low slip clutch for resetting may comprise a plurality of obtuse angled teeth 58 circularly arranged on the selector mating surface 59 and a plurality of depressions 69 circularly arranged on the actuator mating surface 89, wherein said teeth 58 mate into said depressions 69 and are positioned between the actuator 25 and the selector 55 forming a low torque clutch, wherein rotation of the actuator 25 with respect to the selector 55 causes said teeth 25 to slip and to remate with the plurality of obtuse angled depressions 69.

A method for resetting the rotational direction of a rotating anvil, output or drive member 10 of a pneumatic ratchet wrench 100, said method comprising providing a shifting linkage or transfer member 30 having a first end 31 functionally attached to a switch 40 configured for user activation, said linkage 30 further having a second end 31 that operatively engages an actuator 25. Furthermore, providing a selector 55 moveably attached to the actuator 25, said selector 55 causes movement of a pawl 75 to change the direction of rotation of a ratchet mechanism 77. Further still providing a low torque clutch 59, 69 between the selector 55 and the actuator 25.

With the wrench 100 provided then start by activating said switch 40 causing rotation of the actuator 25 causing either direction of said rotating anvil or output 10 to change from a first position to a second position or rotation of the selector 55 with respect to the actuator 25 to reset lost timing. The actuator 25 and the selector 55 are moveably attached to each other to allow for rotation with respect to each other. The selector 55 may have just a first position and a second position, associated with either a forward or reverse rotation of the drive member 10 after movement of the pawl 75. When the switch 40 is indicated to be in one position and the selector 55 is in an opposite position the movement of the switch 40 causes the actuator 25 to move with respect to the selector 55 so that the switch position then corresponds with the selector position 55.

Various modifications and variations of the described apparatus and methods of the invention will be apparent to those skilled in the art without departing from the scope and spirit of the invention Although the invention has been described in connection with specific embodiments, outlined above, it should be understood that the invention should not be unduly limited to such specific embodiments. Various changes may be made without departing from the spirit and scope of the invention as defined in the following claims.

We claim:

1. A selector of a ratchet and pawl system comprising:
an actuator; and
a selector having a first ratchet position and a second ratchet position, said selector is moveably attached to the actuator, wherein orientation between said selector and said actuator is resettable.

2. The selector of claim 1 further comprising:
a plurality of gear teeth on the actuator configured for operative engagement with a switch

3. The selector of claim 1 further comprising:
a reset clutch positioned between the actuator and the selector.

4. The selector of claim 1 comprising:
a first actuator position that causes an anvil to rotate in a forward rotational direction; and
a second actuator position that causes the anvil to rotate in a reverse rotational direction.

5. The selector of claim 1 further comprising:
a biasing element; and
a fastener moveably joining the actuator and the selector, said biasing element provides tension between the actuator and the selector.

6. The selector of claim 1 further comprising:
a selector mating surface on the selector; and
an actuator mating surface on the actuator, wherein the selector mating surface and the actuator mating surface are in a frictional lock, wherein said actuator and said selector rotate as a single unit until the frictional lock is exceeded by a force applied to move said actuator.

7. The selector of claim 1, further comprising:
a low torque geared slip clutch surface positioned between an end of the selector and an end of the actuator.

8. The selector of claim 1, further comprising:
a plurality of obtuse angled teeth circularly arranged; and
a plurality of depressions circularly arranged, wherein said teeth mate into said depressions and are positioned between the actuator and the selector forming a low torque clutch, wherein rotation of the actuator with respect to the selector causes said teeth to slip and to remate with the plurality of obtuse angled teeth.

9. The selector of claim 1, further comprising:
at least one chamber configured to accept a spring to keep a pawl in tension.

10. A pneumatic ratchet wrench with resettable shifting linkage comprising:
a housing;
a rotating output;
a motor positioned within the housing;
a ratchet assembly having at least one pawl coupled to the rotating output and the motor;
a transfer rod, said rod having a first end and a second end;
a switch mounted on the housing and configured for user activation, said switch functionally attached to the first end of the transfer rod;
an actuator that operatively engages a second end of the transfer rod during movement of the switch; and
a selector to move said pawl, said selector having a first ratchet position and a second ratchet position to control direction of the rotating output, said selector is moveably attached to the actuator, wherein orientation between said selector and said actuator is resettable.

11. The apparatus of claim 10 further comprising:
a plurality of obtuse angled teeth circularly arranged; and
a plurality of depressions circularly arranged, wherein said teeth mate into said depressions and are positioned between the actuator and the selector forming a low torque clutch, wherein rotation of the actuator with respect to the selector causes said teeth to slip and to remate with the plurality of obtuse angled teeth to reset timing.

12. The apparatus of claim 10 further comprising:
a plurality of gear teeth on the actuator for engagement with said second end.

13. The apparatus of claim 10 further comprising:
at least one frictional surface positioned between the actuator and the selector.

14. The apparatus of claim 10 comprising:
a first switch position that causes the anvil to rotate in a forward rotational direction; and
a second switch position that causes the anvil to rotate in a reverse rotational direction.

15. The apparatus of claim 10 comprising:
a washer providing a biasing force between said selector and said actuator.

16. A pneumatic ratchet wrench with resettable shifting linkage comprising:
a housing;
a motor positioned within the housing;
a ratchet assembly having at least one pawl coupled to the motor;
a transfer rod, said rod having a first end and a second end;
a switch mounted on the housing and configured for user activation, said switch functionally attached to the first end of the transfer rod;
an actuator that operatively engages a second end of the transfer rod during movement of the switch;
a selector to move said pawl; and
a biasing element moveably joining the actuator and the selector, said biasing element provides tension between the actuator and the selector allowing resetting of the selector switch when force from the selector switch exceeds the force of the biasing element.

17. The wrench of claim 16 further comprising:
a selector mating surface on the selector; and
an actuator mating surface on the actuator, wherein the selector mating surface and the actuator mating surface are in a frictional lock, wherein said actuator and said selector rotate as a single unit until the frictional lock is exceeded by the movement of the selector.

18. The shifting linkage of claim 16, further comprising:
a low torque geared slip clutch surface positioned between an end of the selector and an end of the actuator.

19. The shifting linkage of claim 17 further comprising:
a plurality of obtuse angled teeth circularly arranged on the selector mating surface; and
a plurality of depressions circularly arranged on the actuator mating surface, wherein said teeth mate into said depressions and are positioned between the actuator and the selector forming a low torque clutch, wherein rotation of the actuator with respect to the selector causes said teeth to slip and to remate with the plurality of obtuse angled teeth.

20. A method for resetting the rotational direction of a rotating anvil of a pneumatic ratchet wrench, said method comprising:
providing a shifting linkage having a first end functionally attached to a switch configured for user activation, said linkage further having a second end that operatively engages an actuator;
providing a selector moveably attached to the actuator, said selector causes movement of a pawl to change the direction of rotation of a ratchet mechanism;
providing a low torque clutch between the selector and the actuator;
activating said switch causing rotation of the actuator causing either direction of said rotating anvil to change from a first position to a second position or rotation of the selector with respect to the actuator to rest lost timing.
